(19) United States
(12) Patent Application Publication
(10) Pub. No.: US 2011/0216835 A1
(43) Pub. Date: Sep. 8, 2011

(54) EDGE FILTER WITH A SHARING ARCHITECTURE AND RELATED METHOD FOR SHARING THE EDGE FILTER UNDER A PLURALITY OF VIDEO STANDARDS

(76) Inventor: Shu-Hsien Chou, Tainan County (TW)

(21) Appl. No.: 12/715,403

(22) Filed: Mar. 2, 2010

(51) Int. Cl. H04N 7/12

(52) U.S. Cl. 375/240.25; 375/E07.027

(57) ABSTRACT

An edge filter includes an input unit and a shared edge filter module. The input unit receives first original pixels of a first decoded block and second original pixels of a second decoded block. The shared edge filter module includes a shared intermediate value generator and a filtering unit. The shared intermediate value generator generates shared intermediate values by making use of original pixels selected from the first original pixels and the second original pixels according to a coefficient rule of coefficients of the first and second original pixels under a designated video standard. The filtering unit filters the first original pixels and the second original pixels to generate a plurality of first filtered pixels and a plurality of second filtered pixels by reference to the coefficient rule. At least two of the first filtered pixels and the second filtered pixels are derived from the shared intermediate value.

### BACKGROUND OF THE INVENTION

1. Field of the Invention

The present invention relates to an edge filter with a sharing architecture and related method, and more particularly, to an edge filter which can generate shared intermediate values according to coefficient rules of coefficients of a plurality of original pixels under various kinds of video standards, such that the edge filter can filter vertical edges or horizontal edges between decoded blocks by reference to the shared intermediate values.

2. Description of the Prior Art

A multi-format video decoder is capable of supporting various kinds of video standards, such as an MPEG-4 specification, a VC-1 specification, an H.264/AVC specification, a RMVB specification, or an AVS specification. In general, an edge filter is applied to decoded blocks/decoded macroblocks in order to reduce blocking distortion. The edge filter can smooth edges between decoded blocks/decoded macroblocks to improve the appearance of decoded frames, such that compression performance can be improved.

Typically, individual hardware components of the edge filters are required for a multi-format video decoder under different specifications. As a result, individual hardware components may increase cost and occupy chip areas.

Hence, how to save the cost and the chip areas of the edge filter for the multi-format video decoder have become an important topic of the field.

### SUMMARY OF THE INVENTION

It is one of the objectives of the claimed invention to provide an edge filter with a sharing architecture and a related method to solve the abovementioned problems.

According to one embodiment, an edge filter with a sharing architecture is provided. The edge filter includes an input unit and a shared edge filter module. The input unit receives a plurality of first original pixels of a first decoded block and a plurality of second original pixels of a second decoded block. The shared edge filter module is coupled to the input unit and supporting a plurality of video standards. The shared edge filter module includes a shared intermediate value generator and a filtering unit. The shared intermediate value generator is coupled to the input unit, for generating at least one shared intermediate value by making use of original pixels selected from the plurality of first original pixels and the plurality of second original pixels according to a coefficient rule of coefficients of the plurality of first original pixels and the plurality of second original pixels under a designated video standard. The filtering unit filters the plurality of first original pixels and the plurality of second original pixels to generate a plurality of first filtered pixels and a plurality of second filtered pixels by reference to the coefficient rule. At least two of the first filtered pixels and the second filtered pixels are derived from the shared intermediate value.

According to another embodiment, a method for sharing an edge filter under a plurality of video standards is provided. The edge filter is capable of filtering vertical edges or horizontal edges between decoded blocks. The method includes steps of: receiving a plurality of first original pixels of a first decoded block and a plurality of second original pixels of a second decoded block; generating at least one shared intermediate value by making use of original pixels selected from the plurality of first original pixels and the plurality of second original pixels according to a coefficient rule of coefficients of the plurality of first original pixels and the plurality of second original pixels under a designated video standard; and filtering the plurality of first original pixels and the plurality of second original pixels to generate a plurality of first filtered pixels and a plurality of second filtered pixels by reference to the coefficient rule; wherein at least two of the first filtered pixels and the second filtered pixels are derived from the shared intermediate value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating vertical edges or horizontal edges between decoded blocks.

FIG. 2 is a block diagram of an edge filter with a sharing architecture according to a first embodiment of the present invention.

FIG. 3 is a block diagram of an edge filter with a sharing architecture according to a second embodiment of the present invention.

FIG. 4 is a table showing a first exemplary embodiment of coefficient rules of coefficients of the plurality of first original pixels and the plurality of second original pixels under a plurality of video standards.

FIG. 5 is a diagram showing an exemplary embodiment of the first filter module acts as a strong filter shown in FIG. 3.

FIG. 6A and FIG. 6B are diagrams of a table (including 60A and 60B) showing a second exemplary embodiment of coefficient rules of coefficients of the plurality of first original pixels and the plurality of second original pixels under a plurality of video standards.

FIG. 7 is a simplified diagram showing an exemplary embodiment of the second filter module acts as a normal/weak filter shown in FIG. 3.

FIG. 8 is a flowchart illustrating a method for sharing an edge filter under a plurality of video standards according to an exemplary embodiment of the present invention.

### DETAILED DESCRIPTION

Certain terms are used throughout the following description and claims to refer to particular components. As one skilled in the art will appreciate, hardware manufacturers may refer to a component by different names. This document does not intend to distinguish between components that differ in name but in function. In the following discussion and in the claims, the terms “include”, “including”, “comprise”, and “comprising” are used in an open-ended fashion, and thus should be interpreted to mean “including, but not limited to . . . ” . The terms “couple” and “coupled” are intended to mean either an indirect or a direct electrical connection. Thus, if a first device couples to a second device, that connection may be through a direct electrical connection, or through an indirect electrical connection via other devices and connections.

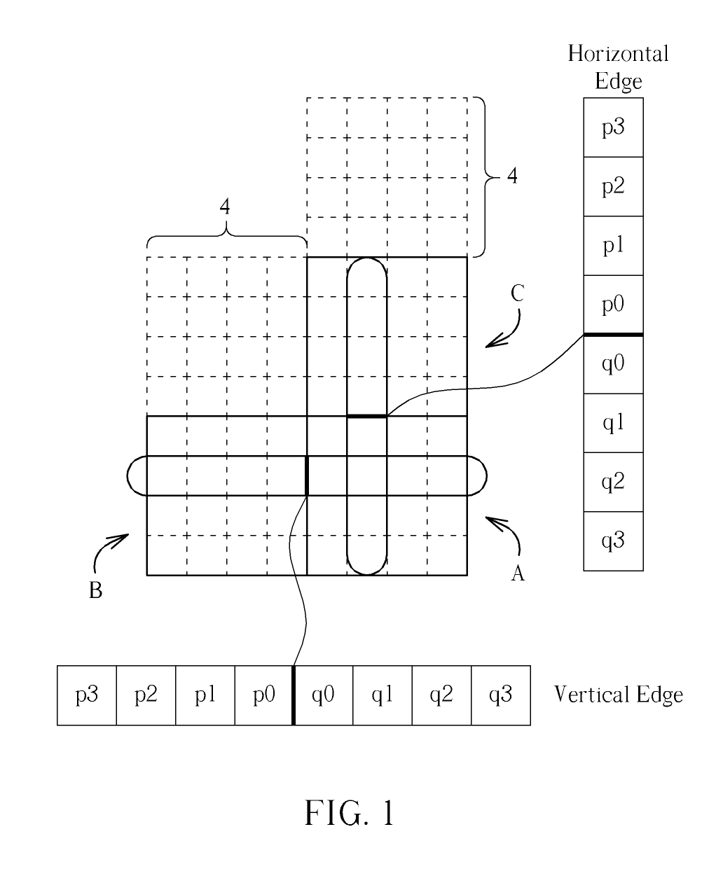

First, in order to make the specification of the present invention easy to understand, a brief description of the algorithm of an edge filter is given as below. FIG. 1 is a diagram illustrating vertical edges or horizontal edges between decoded blocks. As FIG. 1 depicts, each of decoded blocks A, B, and C is a 4×4 block, wherein edges are existed between any two of the decoded blocks. For example, a vertical edge is existed between the decoded block B (including a plurality of first original pixels p0, p1, p2, and p3) and the decoded block A (including a plurality of second original pixels q0, q1, q2, and q3) ; and a horizontal edge is existed between the decoded block C (including a plurality of first original pixels p0, p1, p2, and p3) and the decoded block A (including a plurality of second original pixels q0, q1, q2, and q3). As is already known to one skilled in the art, an edge filter is capable of filtering vertical edges or horizontal edges between decoded blocks, so as to give a higher subjective visual quality. In details, the edge filter may filter the plurality of first original pixels p0˜p3 and the plurality of second original pixels q0˜q3 to generate a plurality of first filtered pixels (e.g. , p0′ ˜p3′)and a plurality of second filtered pixels (e.g. , q0′˜q3′), and thus the filtered pixels p0′˜p3′ and q0′˜q3′ can be used to redefine the original pixels p0˜p3 and q0˜q3.

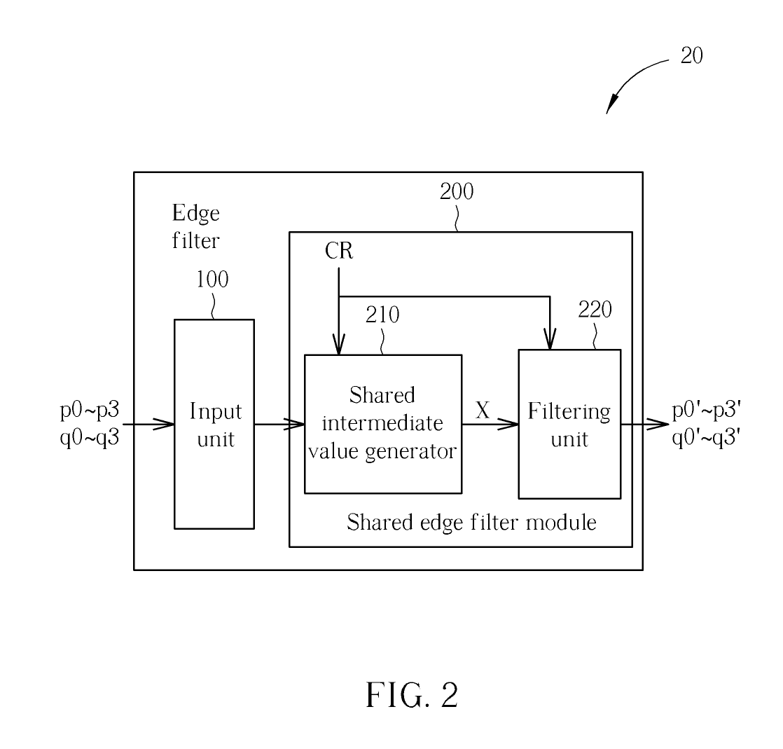

FIG. 2 is a block diagram of an edge filter 20 with a sharing architecture according to a first embodiment of the present invention. The edge filter 20 includes, but is not limited to, an input unit 100 and a shared edge filter module 200. The input unit 100 receives a plurality of first original pixels p0˜p3 of a first decoded block and a plurality of second original pixels q0˜q3 of a second decoded block. The shared edge filter module 200 is coupled to the input unit 100 and supporting a plurality of video standards. Herein the shared edge filter module 200 includes a shared intermediate value generator 210 and a filtering unit 220. The shared intermediate value generator 210 is coupled to the input unit 100, for generating at least one shared intermediate value(s) X by making use of original pixels selected from the plurality of first original pixels p0˜p3 and the plurality of second original pixels q0-q3 according to a coefficient rule CR of coefficients of the plurality of first original pixels p0˜p3 and the plurality of second original pixels q0˜q3 under a designated video standard. After that, the filtering unit 220 filters the plurality of first original pixels p0˜p3 and the plurality of second original pixels q0˜q3 to generate a plurality of first filtered pixels p0′˜p3′ and a plurality of second filtered pixels q0′˜q3′ by reference to the coefficient rule CR.

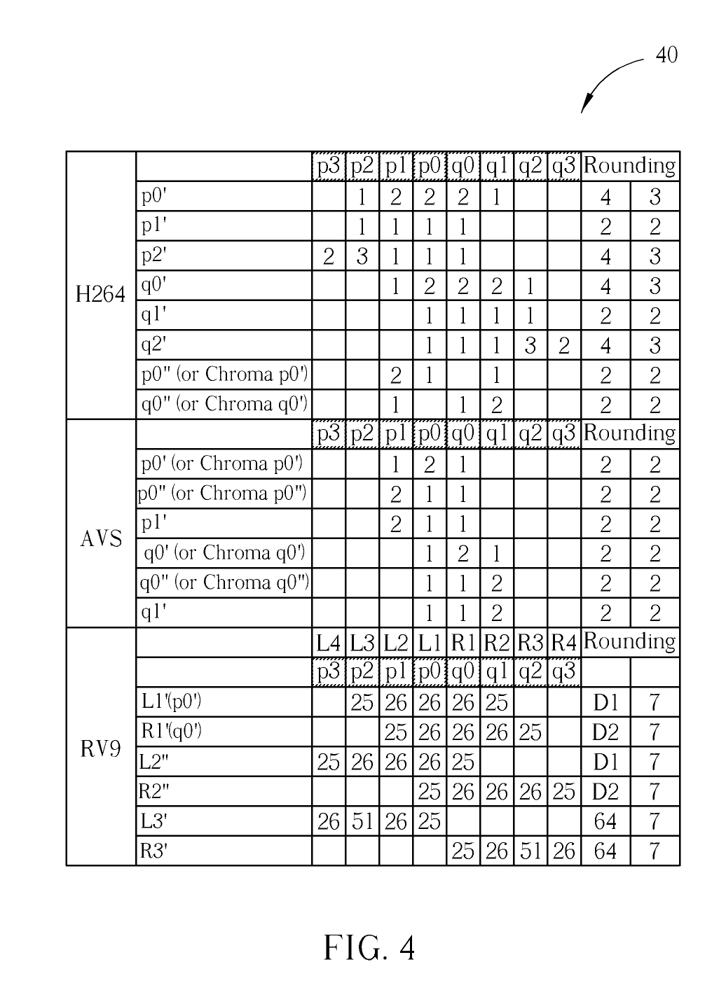

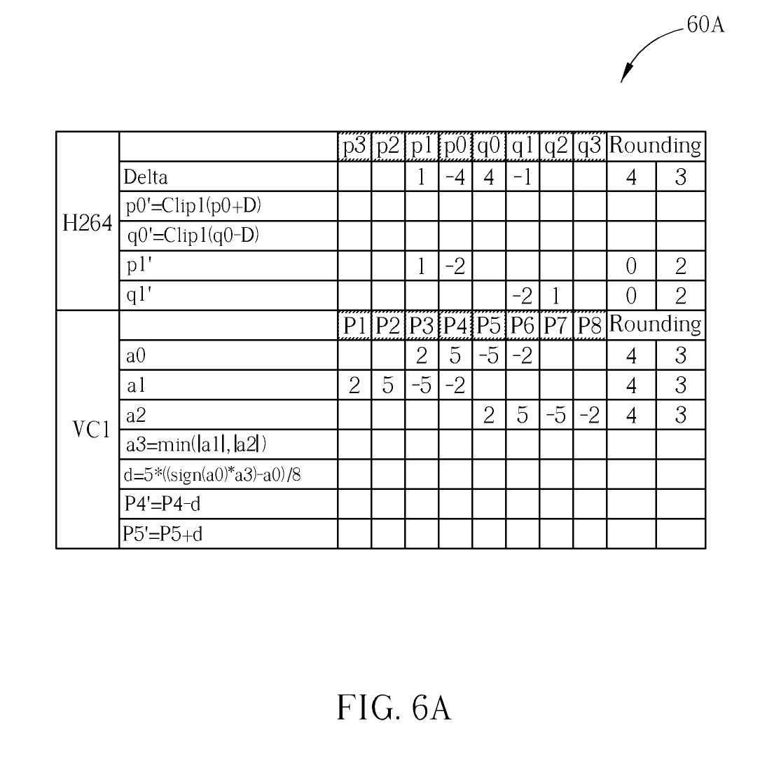

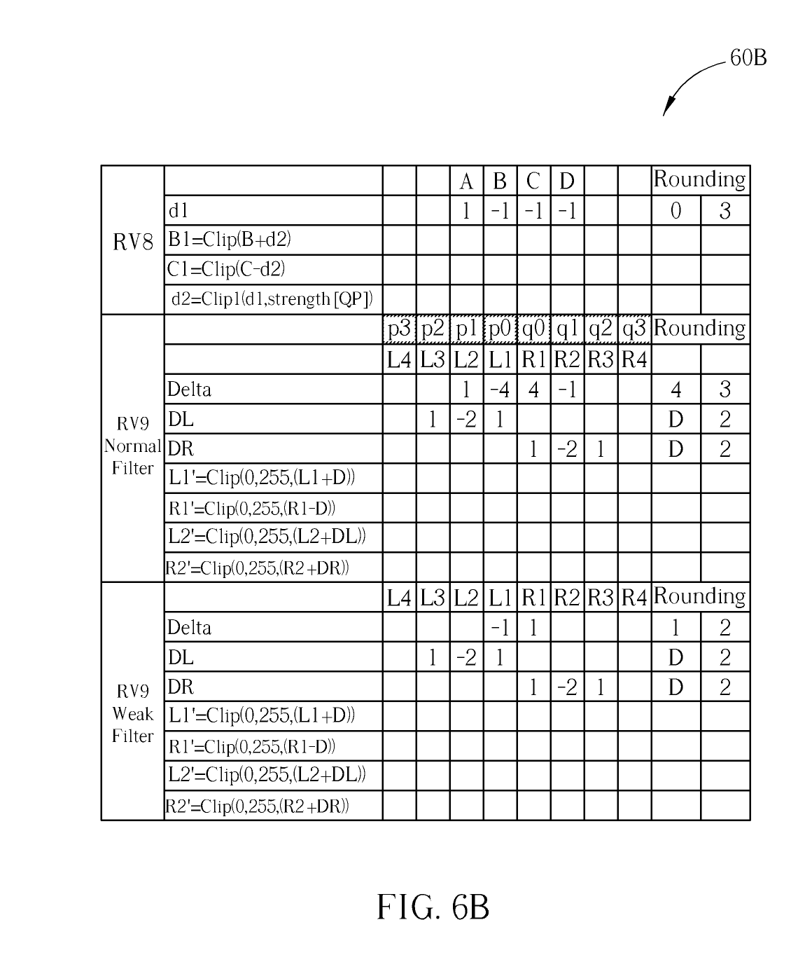

What calls for special attention is that at least two of the first filtered pixels p0′˜p3′ and the second filtered pixels q0′˜q3′ are derived from the shared intermediate value(s) X. In addition, the plurality of first original pixels p0˜p3 and the plurality of second original pixels q0˜q3 have different coefficients under different video standards, and coefficient rules referred to by the shared edge filter module 200 under different video standards are different, which is also shown in FIG. 4 (or FIG. 6A together with FIG. 6B) as below.

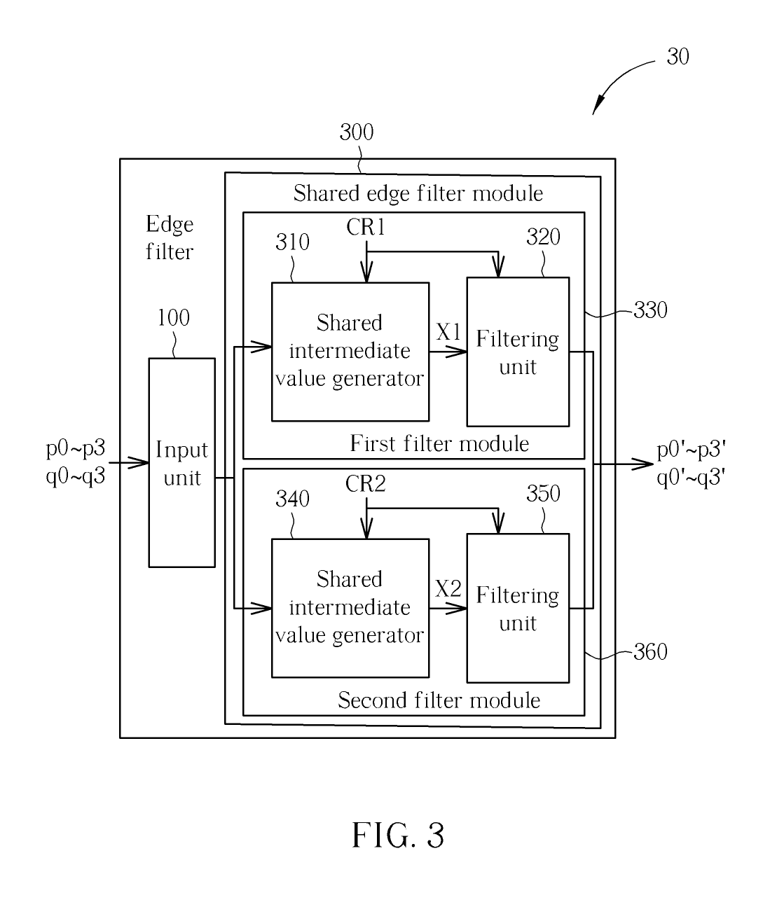

FIG. 3 is a block diagram of an edge filter 30 with a sharing architecture according to a second embodiment of the present invention. The architecture of the edge filter 30 is similar to the edge filter 20 shown in FIG. 2, and the difference between them is that a shared edge filter module 300 of the edge filter 30 includes a first filter module 330 acts as a strong filter and a second filter module 360 acts as a normal/weak filter. Each of the first filter module 330 and the second filter module 360 includes a shared intermediate value generator 310/340 and a filtering unit 320/350. Since operations of the shared intermediate value generator 310/340 and the filtering unit 320/350 are the same as the abovementioned shared intermediate value generator 210 and the filtering unit 220, additional description is omitted here for brevity.

In one word, the shared intermediate value generator 210/310/340 generates the shared intermediate value X/X1/X2 by making use of the plurality of first original pixels p0˜p3 and the plurality of second original pixels q0˜q3 according to the coefficient rule CR/CR1/CR2. After that, the filtering unit 220/320/350 can use the shared intermediate value X/X1/X2 to generate the plurality of first filtered pixels p0′˜p3′ and the plurality of second filtered pixels q0′˜q3′ under various kinds of video standards, such that the vertical edges or horizontal edges between decoded blocks can be filtered.

Please note that the edge filter 20 or 30 disclosed in the present invention can be applied to a multi-format video decoder. Moreover, the video standards may include an H.264/AVC specification, an RMVB specification, or an AVS specification, but this should not be considered as a limitation of the present invention.

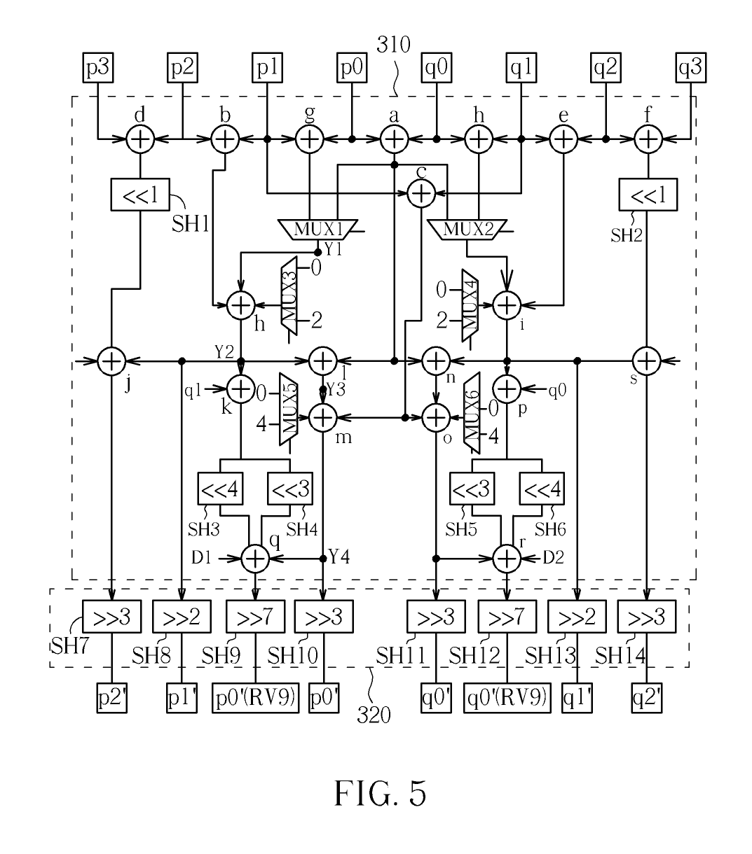

Please refer to FIG. 4 together with FIG. 5. FIG. 4 is a table 40 showing a first exemplary embodiment of coefficient rules of coefficients of the plurality of first original pixels and the plurality of second original pixels under a plurality of video standards, and FIG. 5 is a diagram showing an exemplary embodiment of the first filter module 330 shown in FIG. 3. In this embodiment, the first filter module 330 acts as a strong filter, and it is built by reference to the coefficient rules of the table 40 shown in FIG. 4.

In FIG. 4, the H.264/AVC specification, the AVS specification, and the RMVB specification (including RV9 format) are cited as examples for illustrating the coefficient rules of coefficients of the plurality of first original pixels p0˜p3 and the plurality of second original pixels q0˜q3. As an example, the filtered pixel p0′ for the H.264/AVC specification can be represented by the following expression:

p0′(H.264)=[((p2+2xp1+2xp0+2xq0+q1)+4)>>3] (1);

In other words, the coefficient rule CR1 for the filtered pixel p0′ under the H.264/AVC specification corresponding to (p3,p2,p1,p0,q0,q1,q2,q3) can be represented by (0,1,2,2,2,1,0,0), and thus the term (p2+2xp1+2xp0+2xq0+q1) is obtained. After that, the term (p2+2xp1+2xp0+2xq0+q1) is added by an integer “4”, and then a 3-bit shift is performed upon it for rounding operations, such that a normalized pixel value of the filtered pixel p0′ under the H.264/AVC specification can be obtained.

As another example, the filtered pixel p0′ for the RV9 format can be represented by the following expression:

p0′(RV9)=[(25xp2+26xp1+26xp0+26xq0+25xq1)>>3] (2);

In other words, the coefficient rule CR1 for the filtered pixel p0′ under the RV9 format corresponding to (p3,p2,p1,p0,q0,q1,q2,q3) can be represented by (0,25,26,26,26,25,0,0), and thus the term (25p2+26p1+26p0+26q0+25q1) is obtained. After that, the term (25p2+26p1+26p0+26q0+25q1) is added by an integer “D1”, and then a 7-bit shift is performed upon it for rounding operations, such that a normalized pixel value of the filtered pixel p0′ under the RV9 format can be obtained.

As shown in FIG. 5, the first filter module 210 is built by reference to the coefficient rules of the table 40 shown in FIG. 4. In this embodiment, the first filter module 210 is implemented by a plurality of adders a˜s, a plurality of multiplexers MUX1˜MUX6, and a plurality of bit shifters SH1˜SH14, but this should not be considered as a limitation of the present invention. In addition, the connection manner of these components is already shown in FIG. 5, and further description is omitted here for brevity. What calls for special attention is that the plurality of adders a˜r together with the plurality of multiplexers MUX1˜MUX6 act as the shared intermediate value generator 310 shown in FIG. 3, which can generate the shared intermediate value(s) X1. Furthermore, the bit shifters SH7˜SH14 act as the filtering unit 320 shown in FIG. 3, which can generate the plurality of first filtered pixels (e.g., p0′, p0′(RV9), p1′, and p2′) and the plurality of second filtered pixels (e.g., q0′, q0′ (RV9), q1′, and q2′) by reference to the coefficient rule CR1, wherein these filtered pixels are derived form the shared intermediate value X1.

As an example, at a node Y1, a resultant term (p0+q0) can be obtained when the multiplexer MUX1 selects the result from the adder a to be outputted; at a node Y2, a resultant term (p2+p1+p0+q0) can be obtained when the multiplexer MUX2 selects the integer “2” to be outputted; at a node Y3, a resultant term (p2+p1+2p0+2q0) can be obtained; at the node Y4, a resultant term (p2+2p1+2p0+2q0+q1+4) can be obtained if the multiplexer MUX4 selects the integer “4” to be outputted. Finally, after passing through the bit shifter SH10, a resultant term represented by [((p2+2xp1+2xp0+2xq0+q1)+4)>>] can be obtained, which means the filtered pixel p0′ for the H.264/AVC specification. Since other filtered pixels under different video standards can be obtained by way, and further description is omitted here for brevity.

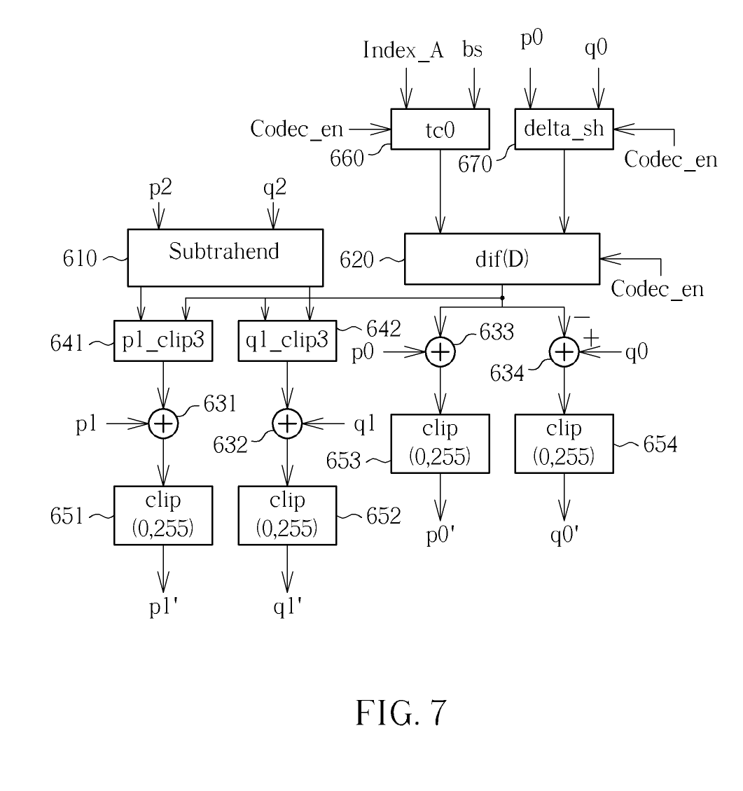

Please refer to FIG. 6A and FIG. 6B together with FIG. 7. FIG. 6A and FIG. 6B are diagrams of a table (including 60A and 60B) showing a second exemplary embodiment of coefficient rules of coefficients of the plurality of first original pixels and the plurality of second original pixels under a plurality of video standards, and FIG. 7 is a simplified diagram showing an exemplary embodiment of the second filter module 360 shown in FIG. 3 . In this embodiment, the second filter module 360 acts as a normal/weak filter, and it is built by reference to the coefficient rules of the table shown in FIG. 6A and FIG. 6B.

As shown in FIG. 6A and FIG. 6B, the H.264/AVC specification, the VC-1 specification, and the RMVB specification (including RV8, RV9 normal filter, and RV9 weak filter formats) are cited as examples for illustrating the coefficient rules of coefficients of the plurality of first original pixels p0˜p3 and the plurality of second original pixels q0˜q3. As an example, the filtered pixel p1′ for the H.264/AVC specification can be represented by the following expression:

p1′(H.264)=[((p2-2xp1)+0)>>2] (3);

In other words, the coefficient rule CR2 for the filtered pixel p1′ under the H.264 /AVC specification corresponding to (p3,p2,p1,p0,q0,q1,q2,q3) can be represented by (0,1,−2,0,0,0,0,0), and thus the term (p2-2xp1) is obtained. After that, the term (p2-2xp1) is added by an integer “0”, and then a 2-bit shift is performed upon it for rounding operations, such that a normalized pixel value of the filtered pixel p1′ under the H.264/AVC specification can be obtained.

As another example, the filtered pixel p0′ (also denoted by

L1′) for the RV9 normal filter format can be represented by the following expression:

L1′(RV9 normal)=Clip (0,255,(L1+D)) (4);

Be noted that the term “D” can be further represented by the following expression:

D=[((p1-4xp0+4xq0-q1)+4)>>3] (5);

In other words, the coefficient rule CR2 for the term “D” under the RV9 normal filter format corresponding to (p3,p2,p1,p0,q0,q1,q2,q3) can be represented by (0, 0, 1, −4, 4, −1, 0, 0), and thus the term (p1-4xp0+4xq0-q1) is obtained. After that, the term (p1-4xp0+4xq0-q1) is added by an integer “4”, and then a 3-bit shift is performed upon it for rounding operations, such that a normalized pixel value of the term “D” under the RV9 format can be obtained, and thereby the filtered pixel p0′ for the RV9 normal filter format can be obtained by adopting the expression (4) listed above.

As shown in FIG. 7, the second filter module 220 is built by reference to the coefficient rules of the table shown in FIG. 6A and FIG. 6B. In this embodiment, the second filter module 220 is implemented by a subtrahend circuit 610, a differentiator 620, an index controller 660, a delta value generator 670, a plurality of adders 631˜634, and a plurality of clipping circuits 641˜642 and 651˜654, but this should not be considered as a limitation of the present invention. In addition, the connection manner of these components is already shown in FIG. 7, and further description is omitted here for brevity. What calls for special attention is that the subtrahend circuit 610, the differentiator 620, the index controller 660, the delta value generator 670, the plurality of adders 631˜634, and the plurality of clipping circuits 641˜642 act as the shared intermediate value generator 340 shown in FIG. 3, which can generate the shared intermediate value(s) X2. Furthermore, the clipping circuits 651˜654 act as the filtering unit 350 shown in FIG. 3, which can generate the plurality of first filtered pixels (e.g. , p0′, and p1′) and the plurality of second filtered pixels (e.g., q0′ and q1′) by reference to the coefficient rule CR2, wherein these filtered pixels are derived form the shared intermediate value(s) X2. Be noted that the index controller 660, the delta value generator 670, and the differentiator 620 are simplified components, which can be dynamically set according to a codec information codec en under various kinds of video standards.

Please note that the embodiments above are merely practicable embodiments of the present invention, and are not meant to be limitations of the scope of the present invention. Certainly, people skilled in the art will readily appreciate that other designs for implementing the shared edge filter module 200 or the shared edge filter module 300 (including the first filter module 330 and the second filter module 360) are feasible.

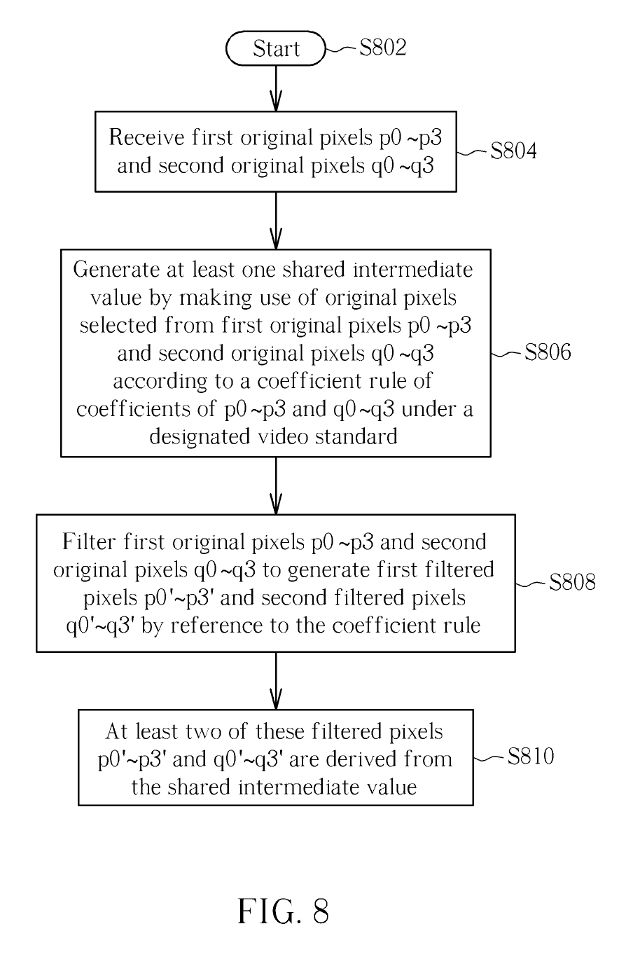

FIG. 8 is a flowchart illustrating a method for sharing an edge filter under a plurality of video standards according to an exemplary embodiment of the present invention. Please note that the following steps are not limited to be performed according to the exact sequence shown in FIG. 8 if a roughly identical result can be obtained. The method includes, but is not limited to, the following steps:

Step S802: Start.

Step S804: Receive a plurality of first original pixels of a first decoded block and a plurality of second original pixels of a second decoded block.

Step S806: Generate at least one shared intermediate value by making use of original pixels selected from the plurality of first original pixels and the plurality of second original pixels according to a coefficient rule of coefficients of the plurality of first original pixels and the plurality of second original pixels under a designated video standard.

Step 808: Filter the plurality of first original pixels and the plurality of second original pixels to generate a plurality of first filtered pixels and a plurality of second filtered pixels by reference to the coefficient rule.

Step 810: At least two of the first filtered pixels and the second filtered pixels are derived from the shared intermediate value.

How each element operates can be known by collocating the steps shown in FIG. 8 and the elements shown in FIG. 2 or FIG. 3, and further description is omitted here for brevity. Be noted that the step S804 is executed by the input unit 100, the step S806 is executed by the shared intermediate value generator 210/310/340, and the steps S808 and 5810 are executed by the filtering unit 220/320/350.

Please note that, the steps of the abovementioned flowchart are merely a practicable embodiment of the present invention, and in no way should be considered to be limitations of the scope of the present invention. The method can include other intermediate steps or several steps can be merged into a single step without departing from the spirit of the present invention.

The abovementioned embodiments are presented merely for describing features of the present invention, and in no way should be considered to be limitations of the scope of the present invention. In summary, the present invention provides an edge filter with a sharing architecture and a related filtering method. By making use of coefficient rules of coefficients of a plurality of original pixels under various kinds of video standards, shared intermediate values can be generated. In addition, the strong filter and/or the normal/weak filter can be built by reference to the coefficient rules, such that the edge filter can share the shared intermediate value(s) to filter the original pixels. Thereby the edge filter, including the shared edge filter module, is capable of filtering vertical edges or horizontal edges between decoded blocks under various kinds of video standards by reference to the shared intermediate values. Therefore, the hardware cost and the chip areas of the edge filter for the multi-format video decoder can be further saved.

Those skilled in the art will readily observe that numerous modifications and alterations of the device and method may be made while retaining the teachings of the invention.

What is claimed is:

1. An edge filter with a sharing architecture, for filtering vertical edges or horizontal edges between decoded blocks, the edge filter comprising:
an input unit, for receiving a plurality of first original pixels of a first decoded block and a plurality of second original pixels of a second decoded block; and
a shared edge filter module, coupled to the input unit and supporting a plurality of video standards, the shared edge filter module comprising:
a shared intermediate value generator, coupled to the input unit, for generating at least one shared intermediate value by making use of original pixels selected from the plurality of first original pixels and the plurality of second original pixels according to a coefficient rule of coefficients of the plurality of first original pixels and the plurality of second original pixels under a designated video standard; and
a filtering unit, coupled to the shared intermediate value generator, for filtering the plurality of first original pixels and the plurality of second original pixels to generate a plurality of first filtered pixels and a plurality of second filtered pixels by reference to the coefficient rule;
wherein at least two of the first filtered pixels and the second filtered pixels are derived from the shared intermediate value.

2 . The edge filter of claim 1, wherein the plurality of first original pixels and the plurality of second original pixels have different coefficients under the plurality of video standards.

3. The edge filter of claim 1, wherein coefficient rules referred to by the shared edge filter module under the plurality of video standards are different.

4. The edge filter of claim 1, wherein the shared edge filter module comprises a first filter module acts as a strong filter and a second filter module acts as a normal/weak filter.

5. The edge filter of claim 4, wherein the first filter module comprises a plurality of adders, a plurality of multiplexers, and a plurality of bit shifters.

6. The edge filter of claim 4, wherein the second filter module comprises a subtrahend circuit, a differentiator, an index controller, a delta value generator, a plurality of adders, and a plurality of clipping circuits.

7. The edge filter of claim 1, being applied to a multi-format video decoder.

8. The edge filter of claim 1, wherein the video standards comprise an H.264/AVC specification, an RMVB specification, or an AVS specification.

9. A method for sharing an edge filter under a plurality of video standards, the edge filter capable of filtering vertical edges or horizontal edges between decoded blocks, the method comprising steps of:
receiving a plurality of first original pixels of a first decoded block and a plurality of second original pixels of a second decoded block;
generating at least one shared intermediate value by making use of original pixels selected from the plurality of first original pixels and the plurality of second original pixels according to a coefficient rule of coefficients of the plurality of first original pixels and the plurality of second original pixels under a designated video standard; and
filtering the plurality of first original pixels and the plurality of second original pixels to generate a plurality of first filtered pixels and a plurality of second filtered pixels by reference to the coefficient rule;
wherein at least two of the first filtered pixels and the second filtered pixels are derived from the shared intermediate value.

10. The method of claim 9, wherein the plurality of first original pixels and the plurality of second original pixels have different coefficients under the plurality of video standards.

11. The method of claim 9, wherein coefficient rules of coefficients of the plurality of first original pixels and the plurality of second original pixels under the plurality of video standards are different.

12. The method of claim 9, wherein the video standards comprise an H.264/AVC specification, a RMVB specification, or an AVS specification.
